(19) United States
(12) Patent Application Publication
(10) Pub. No.: US 2010/0170221 A1
(43) Pub. Date: Jul. 8, 2010

(54) TURBO FAN ENGINE

(75) Inventors: Tadafumi Yoshida, Mishima-shi (JP); Hiroki Tashiro, Aichi-ken (JP)

Correspondence Address: GIFFORD, KRASS, SPRINKLE,ANDERSON & CITKOWSKI, P.C, PO BOX 7021, TROY, MI, 48007-7021, US

(73) Assignee: Toyota Jidosha Kabushiki Kaisha, Toyota-Shi (JP)

(21) Appl. No.: 12/686,025

(22) Filed: Jan. 12, 2010

(30) Foreign Application Priority Data
Jan. 8, 2009 (JP) 2009-002472
Feb. 12, 2009 (JP) JP2009-029929

(51) Int. Cl. F02K 3/02; F01D 17/00

(52) U.S. Cl. 60/226.3; 415/145

(57) ABSTRACT

A turbo fan engine is equipped with a main body portion that has a high-pressure turbine and a low-pressure turbine, an output portion that is provided separately from the main body portion, a gas flow channel that communicates with a space between the high-pressure turbine and the low-pressure turbine and is connected to the output portion, and a flow rate adjustment portion that is provided in the gas flow channel to adjust a flow rate of a gas flowing through the gas flow channel.

### INCORPORATION BY REFERENCE

The disclosure of Japanese Patent Application No. 2009-029929 filed on Feb. 12, 2009 including the specification, drawings and abstract is incorporated herein by reference in its entirety.

### BACKGROUND OF THE INVENTION

1. Field of the Invention

The invention relates to a turbo fan engine.

2. Description of the Related Art

A turbo fan engine for use in an aircraft or the like according to the related art is disclosed in Japanese Patent Application Publication No. 2003-206806 (JP-A-2003-206806). In this turbo fan engine, part of air compressed by a compressor of an engine main body is supplied to an output portion provided separately from the engine main body. Thus, for example, an output for vertical takeoff is obtained at this output portion.

However, in this turbo fan engine, the air for driving the output portion is extracted from an outlet of the compressor. Therefore, the temperature of the air supplied to the output portion is low, and as a result, a small output is obtained.

Further, there is also a lift fan according to the related art that introduces thereinto exhaust gas of a fan of an engine main body portion to obtain an output at the lift fan. However, in this lift fan, the exhaust gas of the fan is low in pressure, and the volume of a fluid flowing through a duct is very large. As a result, the duct is extremely large in size.

### SUMMARY OF THE INVENTION

The invention provides a turbo fan engine capable of increasing an output at an output portion provided separately from a main body of the engine.

One aspect of the invention relates to a turbo fan engine equipped with a main body portion that has a high-pressure turbine and a low-pressure turbine, an output portion that is provided separately from the main body portion, a gas flow channel that communicates with a space between the high-pressure turbine and the low-pressure turbine and is connected to the output portion, and a flow rate adjustment portion that is provided in the gas flow channel to adjust a flow rate of a gas flowing through the gas flow channel.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a schematic cross-sectional view showing a turbo fan engine according to an embodiment of the invention;

FIG. 2 is a view showing a variable stator blade and a rotor blade of the turbo fan engine;

FIG. 3 is a view showing a state of the turbo fan engine shown in FIG. 1 during takeoff;

FIG. 4 is a view showing a state of the turbo fan engine shown in FIG. 1 during cruising; and

FIG. 5 is a schematic cross-sectional view showing a turbo fan engine according to another embodiment of the invention.

### DETAILED DESCRIPTION OF EMBODIMENTS

The embodiments of the invention will be described hereinafter with reference to the accompanying drawings. In describing the drawings, like elements are denoted by like reference symbols, and the same description is omitted.

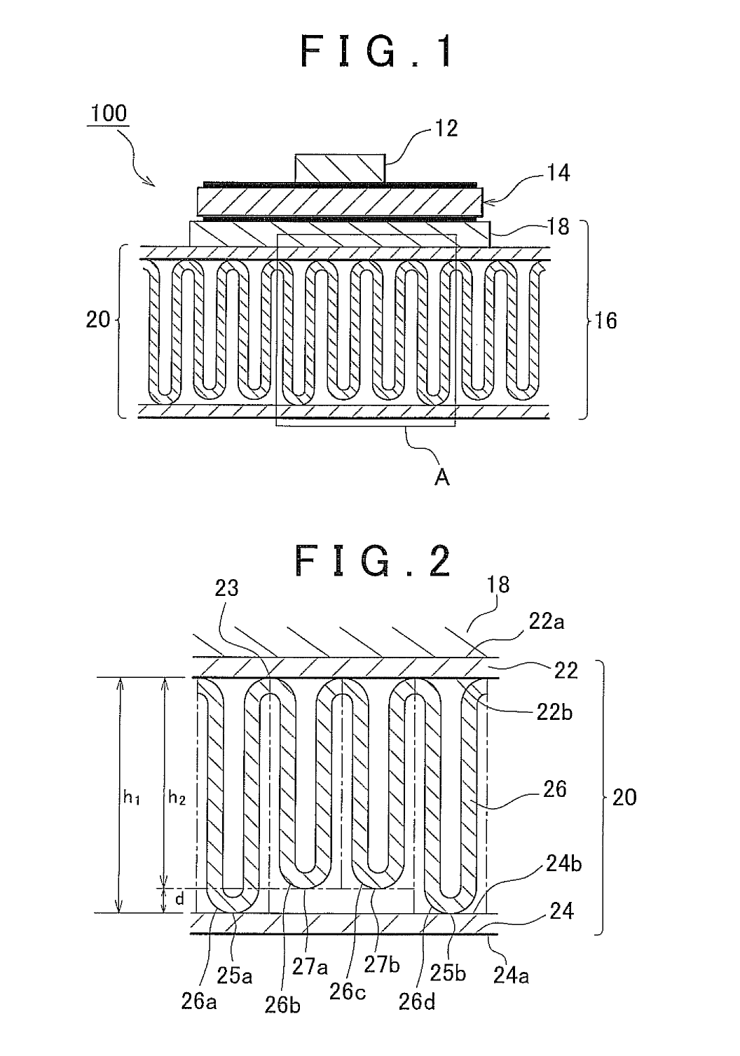

FIG. 1 is a schematic cross-sectional view showing a turbo fan engine according to the first embodiment of the invention. As shown in FIG. 1, a turbo fan engine 1 is mounted on an aircraft to be used as an engine thereof, and is equipped with an engine main body portion 10 and a lift fan 20.

The engine main body portion 10 is fitted to each main wing of the aircraft to serve as a thrust source of the aircraft, and has a front fan 11, a high-pressure compressor 12, a combustor 13, a high-pressure turbine 14, a low-pressure turbine 15, and a squirt nozzle 16 as main components thereof. The high-pressure compressor 12, the combustor 13, the high-pressure turbine 14, and the low-pressure turbine 15 are fitted inside an engine casing 17 and function as a gas turbine.

The front fan 11 is disposed in a front portion of the engine main body portion 10, and is coupled to the low-pressure turbine 15, which is provided in a rear portion of the engine main body portion 10, by a low-speed shaft 18 to be rotatable together with the low-pressure turbine 15. This front fan 11 has the functions of being driven by the low-pressure turbine 15, rotating to take air into the engine main body portion 10, and discharging the air backward to generate a thrust.

The high-pressure compressor 12 is a compressor disposed behind the front fan 11, and is coupled to the high-pressure turbine 14, which is provided anteriorly (at a front portion) of the low-pressure turbine 15, by a high-speed shaft 19 disposed rotatably around the low-speed shaft 18 to be rotatable together with the high-pressure turbine 14. This high-pressure compressor 12 is driven by the high-pressure turbine 14, compresses air flowing into the engine casing 17, and supplies the compressed air to the combustor 13 located posteriorly.

The combustor 13 is disposed between the high-pressure compressor 12 and the high-pressure turbine 14, and is equipped with a fuel injection portion, a combustion chamber, and the like. This combustor 13 mixes fuel with compressed air from the high-pressure compressor 12, and burns the mixture to thereby supply high-temperature high-pressure combustion gas to the high-pressure turbine 14.

The high-pressure turbine 14 is a multiple-stage turbine disposed posteriorly of the combustor 13, and is equipped, on an outer peripheral face of a rotatable main body thereof, with a high-pressure turbine rotor 14a as a rotor blade. Further, the high-pressure turbine 14 is equipped, inside the engine casing 17, with a high-pressure turbine nozzle 14b as a stator blade corresponding to the high-pressure turbine rotor 14a. This high-pressure turbine 14 has the functions of introducing thereinto high-temperature high-pressure combustion gas supplied from the combustor 13, causing the high-pressure turbine rotor 14a to rotate through the pressure of the combustion gas, causing the high-speed shaft 19 to rotate, and driving the high-pressure compressor 12.

The low-pressure turbine 15 is a multiple-stage turbine disposed posteriorly of the high-pressure turbine 14, and is equipped, on an outer peripheral face of a rotatable main body thereof, with a low-pressure turbine rotor 15a as a rotor blade. Further, the low-pressure turbine 15 is equipped, inside the engine casing 17, with a low-pressure turbine nozzle 15b as a stator blade corresponding to the low-pressure turbine rotor 15a. This low-pressure turbine 15 has the functions of introducing thereinto high-temperature combustion gas discharged from the high-pressure turbine 14, causing the low-pressure turbine rotor 15a to rotate through the pressure of the combustion gas, causing the low-speed shaft 18 to rotate, and driving the front fan 11.

Furthermore, this low-pressure turbine 15 has a variable stator blade most anteriorly (at a frontmost portion) of the low-pressure turbine nozzle 15b. FIG. 2 shows variable stator blades 15ba of the low-pressure turbine nozzle 15b and low-pressure turbine rotors 15a. As shown in FIG. 2, each of the variable stator blades 15ba turns with respect to a rotary shaft 15bc thereof over a predetermined range and can thereby be opened/closed.

In an “open” state (as indicated by a solid line of FIG. 2), this variable stator blade 15ba causes high-temperature combustion gas discharged from the high-pressure turbine 14 to flow into a clearance between the low-pressure turbine nozzle 15b and the low-pressure turbine rotor 15a. In a “closed” state (as indicated by alternate long and two short dashes lines of FIG. 2), the variable stator blade 15ba closes a gas flow channel of the low-pressure turbine 15 to thereby shut off the inflow of the combustion gas. The opening degree of this variable stator blade 15ba can be appropriately controlled. As described above, each variable stator blade 15ba has the function of adjusting the flow rate of the combustion gas flowing into the low-pressure turbine 15.

As shown in FIG. 1, the squirt nozzle 16 is a stator blade provided at a rearmost portion of the engine casing 17, and redirects and squirts backward exhaust gas discharged from the low-pressure turbine 15.

The lift fan portion 20 is an output portion provided separately from the engine main body portion 10, and is connected to the engine main body portion 10 by a duct D as a gas flow channel. This lift fan portion 20 is fitted to, for example, a lower portion or the like of a fuselage or each main wing, and sends air downward to apply a vertical thrust, namely, a lift to the fuselage. The lift fan portion 20 has lift fan driving turbines 21 and lift fans 22 as main components thereof. These components are fitted inside lift fan casings 23 respectively.

Each of the lift fan driving turbines 21 is equipped, on an outer peripheral face of a rotatable main body thereof, with a lift fan driving turbine rotor 21b as a rotor blade. Further, each of the lift fan driving turbines 21 is equipped, inside a corresponding one of the lift fan casings 23, with a lift fan driving turbine nozzle 21a as a stator blade corresponding to the lift fan driving turbine rotor 21b. This lift fan driving turbine 21 has the functions of introducing thereinto combustion gas supplied from the engine main body portion 10 through the duct D, and causing the lift fan driving turbine rotor 21b to rotate through the pressure of the combustion gas to thereby drive the lift fan 22.

The lift fan 22 is coupled rotatably together with the lift fan driving turbine 21. This lift fan 22 is driven by the lift fan driving turbine 21, and discharges air downward through rotation thereof to apply a lift to the fuselage.

It should be noted herein that that region of the engine main body portion 10 which is located between the high-pressure turbine 14 and the low-pressure turbine 15 is provided with an inlet portion Da of the duct D connecting the engine main body portion 10 to the lift fan portion 20. In other words, the duct D is so provided as to communicate with a space between the high-pressure turbine 14 and the low-pressure turbine 15. Still in other words, the duct D is provided such that at least part of high-temperature combustion gas discharged from the high-pressure turbine 14 can bypass the low-pressure turbine 15. On the other hand, outlet portions Db of the duct D are inserted in the lift fan casings 23 of the lift fan portion 20 respectively.

Further, the duct D is provided with a valve 25 as a flow rate adjustment portion that adjusts the flow rate of combustion gas flowing through the duct D. The opening degree of this valve 25 can be appropriately controlled. This valve 25 has the function of adjusting, through a change in the opening degree thereof, the flow rate of combustion gas flowing through the duct D.

In the lift fan portion 20 constructed as described above, the valve 25 is opened to allow high-temperature combustion gas discharged from the high-pressure turbine 14 to be supplied to the lift fan driving turbines 21 through the duct D, the lift fan driving turbine rotors 21b are caused to rotate through the pressure of the combustion gas, and the lift fans 22 are driven to generate a lift.

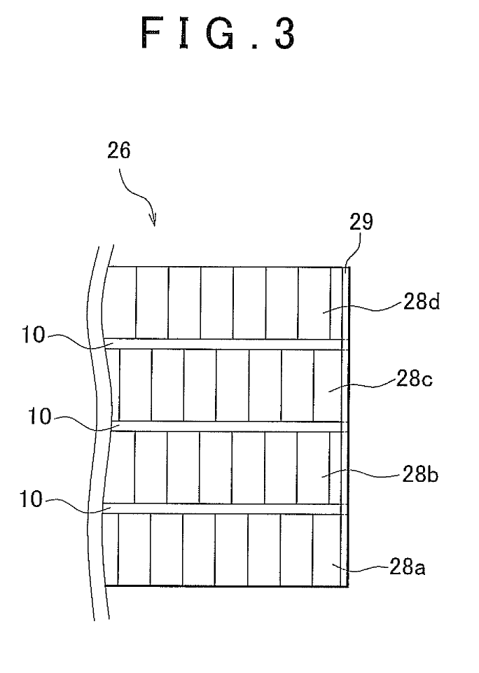

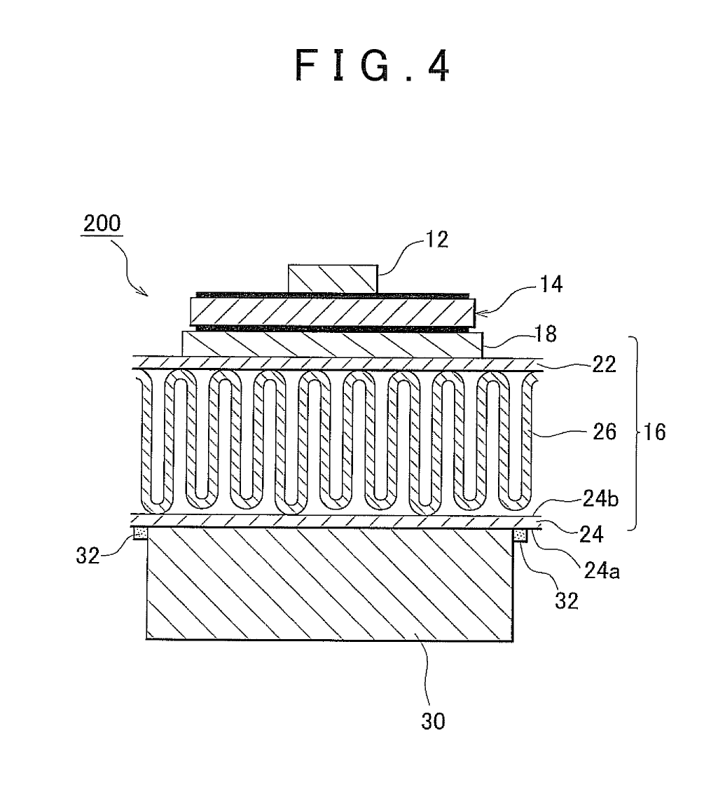

The operation of the turbo fan engine 1 constructed as described above will be described hereinafter. FIG. 3 shows a state of the turbo fan engine 1 during takeoff, and FIG. 4 shows a state of the turbo fan engine 1 during cruising.

First of all, in the state of takeoff shown in FIG. 3, the variable stator blade 15ba is fully closed and the valve 25 is fully open. In this state, when the engine main body portion 10 is operated, the engine main body portion 10 burns fuel in the combustor 13 and supplies high-temperature high-pressure combustion gas to the high-pressure turbine 14. It should be noted in FIG. 3 that the variable stator blade 15ba in its fully closed state is blackened.

The high-pressure turbine 14 introduces thereinto high-temperature combustion gas supplied from the combustor 13, causes the high-pressure turbine rotor 14a and the high-speed shaft 19 to rotate, and drives the high-pressure compressor 12. The high-pressure compressor 12 is driven by the high-pressure turbine 14, compresses air flowing into the engine casing 17, and supplies the combustor 13 with the compressed air.

On the other hand, due to the smallest opening degree of the variable stator blade 15ba, the high-temperature combustion gas discharged from the high-pressure turbine 14 is unlikely to flow into the low-pressure turbine 15 and likely to flow into the lift fan casings 23 of the lift fan portion 20 through the duct D. Due to the high-temperature combustion gas flowing into these lift fan casings 23, the lift fan driving turbines 21 rotate, and the lift fans 22 rotate to generate a lift for allowing the fuselage to take off vertically. Owing to this lift, the fuselage can take off vertically.

Furthermore, the opening degree of the variable stator blade 15ba is gradually increased, and the valve 25 is so controlled as to be gradually closed. Thus, the high-temperature combustion gas discharged from the high-pressure turbine 14 is likely to flow into the low-pressure turbine 15 as well, the low-pressure turbine 15 rotates, and the front fan 11 rotates. Due to rotation of this front fan 11, a thrust for accelerating the fuselage forward is generated to cause an increase in the cruising speed of the fuselage and also an increase in the lift of each main wing. On the other hand, the lift of each of the lift fans 22 decreases.

Then, when the aircraft reaches a predetermined altitude to assume a cruising state shown in FIG. 4, the opening degree of the variable stator blade 15ba is maximized, and the valve 25 is fully closed. Thus, the high-temperature combustion gas discharged from the high-pressure turbine 14 entirely flows into the low-pressure turbine 15 to cause an increase in the thrust of front fan 11. It should be noted in FIG. 4 that the valve 25 in its fully closed state is blackened.

Further, in adjusting the thrust of the aircraft during this cruising, the opening degree of the variable stator blade 15ba is appropriately adjusted, and the flow rate of the combustion gas flowing through the low-pressure turbine 15 is adjusted to control rotation of the low-pressure turbine 15 and the front fan 11. The aircraft can thereby cruise with the efficiency of aerodynamic elements thereof held high, and an improvement in fuel consumption can be made. Further, the loss in the thrust can be reduced.

As described above, in the turbo fan engine 1 according to this embodiment of the invention, the duct D branched off from the space between the high-pressure turbine 14 and the low-pressure turbine 15 is connected to the lift fan portion 20 provided separately from the engine main body portion 10. Further, this duct D is provided with the valve 25. This valve 25 is used to make an adjustment such that the gas flows through the duct D. The high-temperature high-pressure combustion gas burned in the combustor 13 thereby flows past the high-pressure turbine 14, then flows through the duct D, and is supplied to the lift fan portion 20. Therefore, the gas supplied to the lift fan portion 20 is the high-temperature burnt gas. Thus, the output at the lift fan portion 20 of the aircraft can be increased.

Further, in the turbo fan engine 1 according to this embodiment of the invention, the opening degree of the valve 25 is made larger during takeoff of the aircraft than during the cruising of the aircraft. Thus, during takeoff of the aircraft, the opening degree of the valve 25 is made larger than during the cruising of the aircraft, and the flow rate of the combustion gas supplied to the lift fan portion 20 increases. Thus, the lift can be obtained even when the cruising speed of the aircraft is low. As a result, the aircraft can take off with a short run-up or vertically.

Further, in addition to the aforementioned effect, the taxiing distance of the aircraft during takeoff can be shortened. Furthermore, during landing as well, the landing entrance speed of the aircraft can be restrained from becoming too high.

Further, in the turbo fan engine 1 according to this embodiment of the invention, the opening degree of the variable stator blade 15ba provided anteriorly (at the front portion) of the low-pressure turbine 15 is adjusted so that the flow rate of the combustion gas flowing through the low-pressure turbine 15 can be adjusted. Therefore, in conjunction with the adjustment of the flow rate of the gas flowing through the duct D by the valve 25, the outputs at the engine main body portion 10 and the lift fan portion 20 can be controlled more efficiently.

According to the turbo fan engine 1 of this embodiment of the invention, the combustion gas that is higher in pressure and smaller in volume than the gas discharged from the low-pressure turbine 15 is utilized. Therefore, the duct D can be reduced in size and hence can be handled with ease.

The turbo fan engine according to the invention is not limited to the foregoing embodiment of the invention. For example, in the foregoing embodiment of the invention, the case where the opening degree of each variable stator blade 15ba is minimized and the valve 25 is fully open during takeoff has been illustrated. However, the opening degrees of these components may be appropriately adjusted in accordance with the state of the fuselage. For example, both the components may be half open to drive both the front fan 11 and the lift fan 22.

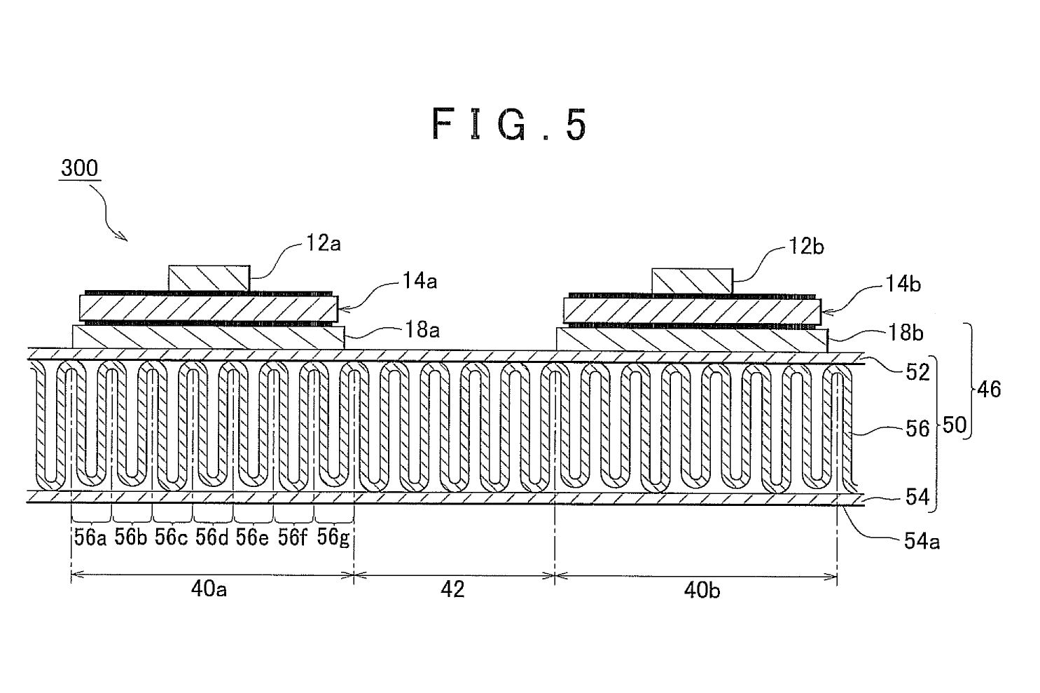

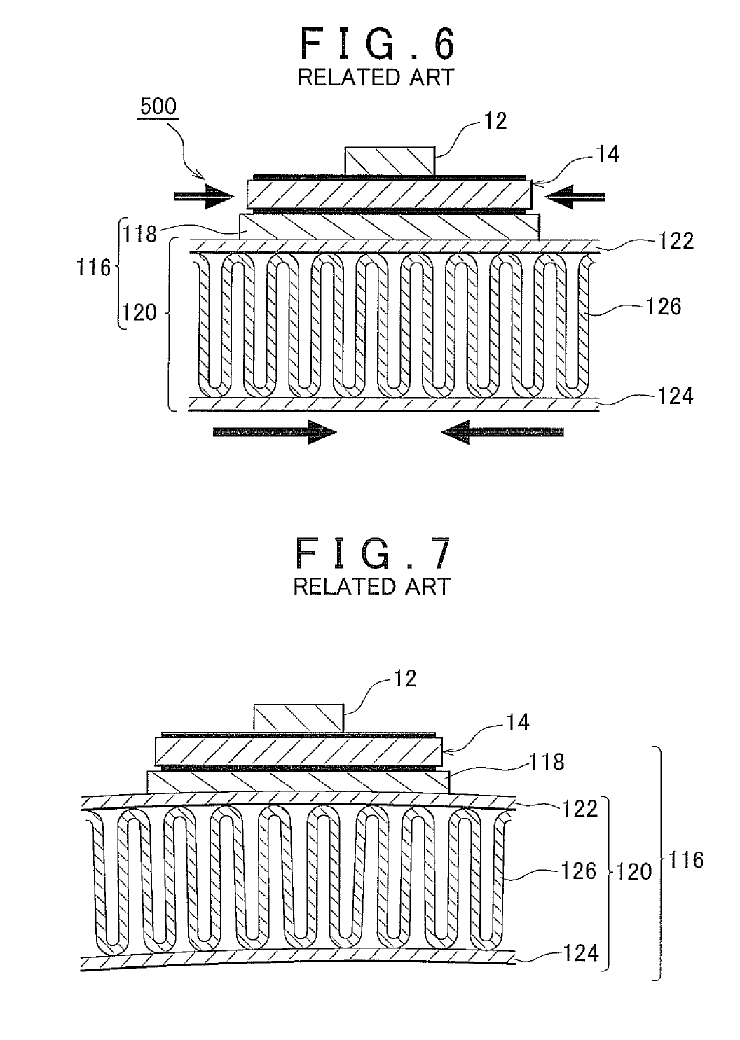

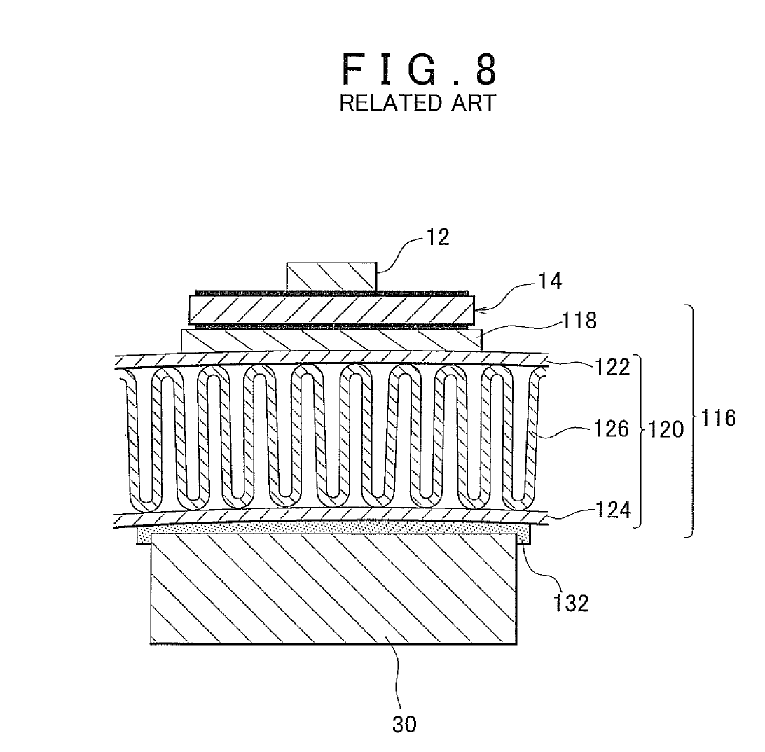

Further, in the foregoing embodiment of the invention, the case where the lift fan portion 20 is provided on the lower portion or the like of the fuselage or each main wing of the aircraft has been illustrated. However, as shown in FIG. 5, it is also appropriate to provide a flap type high lift device 40 at a rear portion of each main wing and connect the duct D to the flap type high lift device 40 to obtain a lift. Furthermore, the output portion of the invention is not absolutely required to produce a lift, but may be, for example, an output portion for posture control or a propellant fan other than the front fan which is optimized for the flying speed.

Further, in the foregoing embodiment of the invention, the case where the turbo fan engine is used as the engine for the aircraft has been illustrated. However, the turbo fan engine according to the invention may be employed for other transport machines or the like, and also for industrial machines other than transport machines.

The outline of the foregoing embodiment of the invention will be described hereinafter. The foregoing embodiment of the invention relates to a turbo fan engine equipped with a main body portion that has a high-pressure turbine and a low-pressure turbine, an output portion that is provided separately from the main body portion, a gas flow channel that communicates with a space between the high-pressure turbine and the low-pressure turbine and is connected to the output portion, and a flow rate adjustment portion that is provided in the gas flow channel to adjust a flow rate of a gas flowing through the gas flow channel.

According to the aforementioned construction, the gas flow channel branched off from the space between the high-pressure turbine and the low-pressure turbine is connected to the output portion provided separately from the engine main body portion. Further, this gas flow channel is provided with the flow rate adjustment portion. This flow rate adjustment portion makes an adjustment such that the gas flows through the gas flow channel. The gas burned in the engine main body portion thereby flows past the high-pressure turbine, then flows through the gas flow channel, and is supplied to the output portion. Thus, since the gas supplied to the output portion is the high-temperature burnt gas, the output at the output portion can be increased.

Further, the turbo fan engine according to the foregoing embodiment of the invention may be used as an engine for an aircraft. The output portion may be a lift fan of the aircraft. The flow rate adjustment portion may be a valve. The valve may have an opening degree that is made larger during takeoff of the aircraft than during cruising of the aircraft.

According to the aforementioned construction, the output can be increased in the lift fan of the aircraft. Further, during takeoff of the aircraft, the opening degree of the flow rate adjustment portion is made larger than during the cruising of the aircraft, and the flow rate of the gas supplied to the lift fan is increased. Therefore, a lift can be obtained even when the cruising speed of the aircraft is low. As a result, the aircraft can take off with a short run-up or vertically.

In the turbo fan engine according to the foregoing embodiment of the invention, the main body portion may further have a combustion chamber in which compressed air is mixed with fuel to be burned, and the air mixed with the fuel may be burned to produce a combustion gas that flows into the high-pressure turbine.

In the turbo fan engine according to the foregoing embodiment of the invention, the gas flowing through the gas flow channel may be the combustion gas discharged from the high-pressure turbine and flow into the output portion.

In the turbo fan engine according to the foregoing embodiment of the invention, the combustion gas flowing into the output portion may be discharged to cause the output portion to output a lift.

Further, in the turbo fan engine according to the foregoing embodiment of the invention, the low-pressure turbine may have at a front portion thereof a variable stator blade whose opening degree is changed, and the opening degree of the variable stator blade may be changed to adjust an amount of the gas flowing into the low-pressure turbine.

According to the aforementioned construction, the flow rate of the gas flowing through the low-pressure turbine can be adjusted through the opening/closing of the variable stator blade provided at the front portion of the low-pressure turbine. Therefore, in conjunction with the adjustment of the flow rate in the gas flow channel by the flow rate adjustment portion, the outputs at the engine main body portion and the output portion can be more efficiently controlled.

In the turbo fan engine according to the foregoing embodiment of the invention, the low-pressure turbine may increase the opening degree of the variable stator blade to increase the amount of the gas flowing into the low-pressure turbine, and may reduce the opening degree of the variable stator blade to reduce the amount of the gas flowing into the low-pressure turbine.

In the turbo fan engine according to the foregoing embodiment of the invention, the low-pressure turbine may reduce the flow rate of the gas flowing into the low-pressure turbine when the flow rate adjustment portion increases the flow rate of the gas flowing through the gas flow channel, and the low-pressure turbine may increase the flow rate of the gas flowing into the low-pressure turbine when the flow rate adjustment portion reduces the flow rate of the gas flowing through the gas flow channel.

In the turbo fan engine according to the foregoing embodiment of the invention, the gas flowing into the low-pressure turbine may be the combustion gas discharged from the high-pressure turbine.

In the turbo fan engine according to the foregoing embodiment of the invention, the gas caused to flow into the low-pressure turbine may be discharged from the low-pressure turbine to cause the main body portion to generate a thrust.

While the embodiments of the invention have been illustrated above, it is to be understood that the invention is not limited to the details of the illustrated embodiments, but may be embodied with various changes, modifications or improvements, which may occur to those skilled in the art, without departing from the scope of the invention.

What is claimed is:

1. A turbo fan engine comprising:
a main body portion that has a high-pressure turbine and a low-pressure turbine;
an output portion that is provided separately from the main body portion;
a gas flow channel that communicates with a space between the high-pressure turbine and the low-pressure turbine and is connected to the output portion; and
a flow rate adjustment portion that is provided in the gas flow channel to adjust a flow rate of a gas flowing through the gas flow channel.

2. The turbo fan engine according to claim 1, which is used as an engine for an aircraft, wherein
the output portion is a lift fan of the aircraft,
the flow rate adjustment portion is a valve, and
the valve has an opening degree that is made larger during takeoff of the aircraft than during cruising of the aircraft.

3. The turbo fan engine according to claim 1, wherein
the main body portion further has a combustion chamber in which compressed air is mixed with fuel to be burned, and
the air mixed with the fuel burns to produce a combustion gas that flows into the high-pressure turbine.

4. The turbo fan engine according to claim 3, wherein the gas flowing through the gas flow channel is the combustion gas discharged from the high-pressure turbine and flows into the output portion.

5. The turbo fan engine according to claim 4, wherein the combustion gas flowing into the output portion is discharged to cause the output portion to output a lift.

6. The turbo fan engine according to claim 4, wherein
the low-pressure turbine has at a front portion thereof a variable stator blade whose opening degree is changed, and
the opening degree of the variable stator blade is changed to adjust an amount of the gas flowing into the low-pressure turbine.

7. The turbo fan engine according to claim 6, wherein the low-pressure turbine increases the opening degree of the variable stator blade to increase the amount of the gas flowing into the low-pressure turbine, and reduces the opening degree of the variable stator blade to reduce the amount of the gas flowing into the low-pressure turbine.

8. The turbo fan engine according to claim 7, wherein
the low-pressure turbine reduces the flow rate of the gas flowing into the low-pressure turbine when the flow rate adjustment portion increases the flow rate of the gas flowing through the gas flow channel, and
the low-pressure turbine increases the flow rate of the gas flowing into the low-pressure turbine when the flow rate adjustment portion reduces the flow rate of the gas flowing through the gas flow channel.

9. The turbo fan engine according to claim 6, wherein the gas flowing into the low-pressure turbine is the combustion gas discharged from the high-pressure turbine.

10. The turbo fan engine according to claim 6, wherein
the gas caused to flow into the low-pressure turbine is discharged from the low-pressure turbine to cause the main body portion to generate a thrust.
